(19) United States
(12) Patent Application Publication
(10) Pub. No.: US 2024/0248697 A1
(43) Pub. Date: Jul. 25, 2024

(54) PERFORMING UPDATES OVER MULTIPLE DEVICES

(71) Applicants: Getac Technology Corporation, New Taipei City (TW); WHP Workflow Solutions, Inc., North Charleston, SC (US)

(72) Inventors: Muhammad ADEEL, Edina, MN (US); Thomas GUZIK, Edina, MN (US)

(21) Appl. No.: 18/100,435

(22) Filed: Jan. 23, 2023

(51) Int. Cl. G06F 8/65; H04L 67/00

(52) U.S. Cl. CPC G06F 8/65; H04L 67/34

(57) ABSTRACT

This disclosure describes techniques for a device configured as a hub to facilitate software updating of hub-connected devices. To some degree or another, these hub-connected devices may often provide overlapping functionality. Operating the hub-connected devices at full or near full functionality may result in duplicative services, some of which may be unused. In some embodiments, the duplicative services may be leveraged, for example, to perform the software updating of the hub-connected devices with least disruption on its functionality and desired use during field operations.

### BACKGROUND

Police officers carry various types of equipment on their person and in their vehicles. Each of these devices may perform various functions. For example, a body camera may be configured to record audio and video. A radio may be configured to transmit and receive audio. A mobile device may be configured to transmit and receive data over a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system that is configured to manage the functionality of various devices.

FIG. 2 illustrates an example server that is configured to manage the functionality of various devices.

FIG. 3 is a flowchart of an example process for managing the functionality of various devices.

FIG. 4 is a flowchart of an example process for managing the functionality of various devices.

### DETAILED DESCRIPTION

A law enforcement officer (LEO) often carries multiple devices in addition to one or more devices that can be installed in a vehicle of the LEO. These devices may form a personal area network (PAN) of devices where one device can be configured as a master device (referred to herein as a hub at times) while other devices that are connected to the configured master device can be referred to as hub-connected devices. Once a PAN device is designated or configured as the hub, then the PAN device may manage some or all of the other PAN devices until another PAN device is configured as the new hub in which case, the management is handed over to the other PAN device. The hub can be LEO's mobile device, a fixed laptop attached to the LEO vehicle, or another PAN device that can be configured to be the hub for a certain time period or upon detection of a triggering event. For example, the vehicle laptop may be preconfigured as the hub when one or more of the PAN devices are connected with each other via a direct wireless communication interface. In another example, the LEO's mobile device may be configured as the hub when a signal strength of the direct wireless communication interface between the LEO's mobile device and the laptop is below a threshold value. In these examples, each of the PAN devices may have a capability and authorization to form the PAN and/or manage some or all of the PAN devices when designated as the hub.

Each of the (PAN) devices has a set of functionalities, software for each functionality or for the set of functionalities, and a power source to carry out these functions. In some implementations, these devices may often provide overlapping functionality. For example, operating the devices at full or near full functionality may result in duplicative services that can result to unnecessary use of device memory spaces and/or battery power. In this regard, the duplicative services may be leveraged, for example, by the hub to perform software update in the device functionality and thus, avoid the unnecessary use of the device memory spaces and/or battery power in the process.

For example, a police vehicle laptop's camera, an LEO's body camera, and an LEO's mobile device may form a PAN of devices and be activated to capture a real-time multimedia stream during a field operation. In this example, the designated or preconfigured hub may suspend capturing functionality of at least one of these PAN devices to pave the way for a software update in the PAN device with suspended capturing functionality.

In one embodiment, the hub may receive data of the hub-connected devices from a network operating center (NOC) server that manages the field operations of the LEOs and their associated devices. In another embodiment, the hub may receive the data directly from one or more of the hub-connected devices. The received data may include, without limitation, device identifiers, device authorization to form or join the formed PAN, device functionalities, identification of installed software, sources of the software update, data size for the software update, and the like. The received data may be used by the hub in managing some or all of the devices in the formed PAN. As described herein, software updating may include receiving of a notification of a new device driver update for an existing or new device function, receiving of data for a new device driver update, installing a new device driver update to the corresponding device, and/or the like, or a combination thereof. The software update may include an over the air software (SOTA) or firmware (FOTA) update, for example.

In some embodiments, the hub is a device that facilitates the software updating for some or all of the hub-connected devices in the formed PAN. A PAN device may be configured as the hub by a network server such as the NOC server for a certain time period or upon the detection of a triggering event. The detection of the triggering event may be preconfigured among the formed PAN of devices, or the NOC server can perform the detecting and then designate the hub in the PAN of devices. For example, the NOC server may use a distance threshold between current geolocations of the LEO's mobile device and the vehicle laptop to detect the triggering event. When designated as the hub, the hub may determine a timing of performing the software update to improve or maximize efficiency of field operation use of the PAN devices. For example, the hub may detect presence of duplicative services when multiple devices in the formed PAN are performing the same function of capturing the same audio content. In this example, the hub may suspend a functionality of one of the PAN devices to perform the software update without affecting the service of capturing the audio content.

The details of one or more implementations of the subject matter described in this specification are set forth in the accompanying drawings and the description below. Other features, aspects, and advantages of the subject matter will become apparent from the description, the drawings, and the claims.

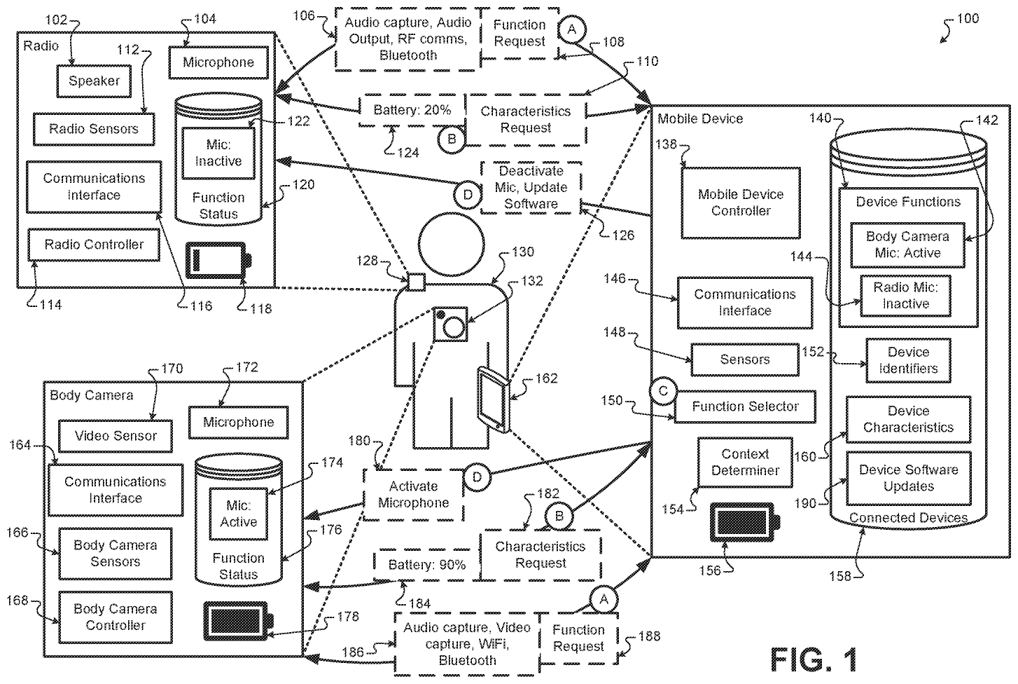

FIG. 1 illustrates an example system 100 that may implement a management by a configured hub of the functionality of various devices. Briefly, and as described in more detail below, a user 130 may be utilizing multiple devices that can be configured to communicate with each other to form a personal area network (PAN) of devices that are associated with the user 130. The PAN devices may include a body camera 132, a radio 128, and a mobile device 162. For purposes of illustration, the mobile device 162 in FIG. 1 may be configured as the hub that manages the operations of the hub-connected devices such as the radio 128 and the body camera 132. The configuration of the mobile device 162 as the hub may be configured permanently or transferred to another PAN device in some implementations.

As the configured hub, the mobile device 162 may receive data of the hub-connected devices from a NOC server (not shown) or directly from one or more of the hub-connected devices. Here, the mobile device 162 may use the received data to determine the various functionalities of the body camera 132 and the radio 128, and determine that some of the functions are used for the same purpose, such as capturing of a video and/or audio data. By leveraging the detected presence of duplicative functionalities between the PAN devices including the hub, the hub may perform software updating during field operations with minimal to no effect on capturing desired video and/or audio data. FIG. 1 includes various stages A through D that may illustrate the performance of actions and/or the movement of data between various components of the system 100.

The user 130 may be a police officer and associated with the radio 128 that includes a speaker 102, microphone 104, and a communications interface 116. The microphone 104 may detect audio during field operations and send the detected audio to the NOC server for via the communications interface 116. The speaker 102 may receive audio data from the user 130 or the NOC server and transform the audio data into audible sounds. In one embodiment, the communications interface 116 may be used to receive a software update notification for the radio 128. The software update notification may be transmitted by a service provider that is registered in data of the radio 128 as an authorized provider of the device driver update, for example. In other cases, the software update notification may be received from the hub-mobile device 162 that relays the notification from the authorized provider. In some implementations, the software update may be pushed to the radio 128 or any other hub-connected device without the software update notification either from the authorized provider of the device driver update and/or the hub-mobile device 162

The radio 128 may include one or more radio sensors 112 to detect characteristics of an environment at a geolocation of the radio 128. For example, the radio sensors 112 may include an accelerometer, a gyroscope, a GPS receiver, a barometer, an ambient light sensor, a compass, a gravity sensor, a proximity sensor, and/or any other similar sensors. As described herein, the detected characteristics of the environment may be used as a reference for installing of the software update. In this example, the radio 128 also may include a battery 118 to provide power to the sensors 112 and the other components of the radio 128.

The radio 128 may include a radio controller 114 that can be configured to manage some or all of the components of the radio 128. The radio controller 114 may be implemented by one or more processors executing software stored on a storage device accessible by the processors. The corresponding software for the components of the radio 128 may be updated on the fly, at an interval period, or upon receiving of an instruction from the hub-mobile device 162. In one embodiment, the radio controller 114 may manage the processing of the audio data from the microphone 104 or process the sensor data from the radio sensors 112.

In one embodiment, the radio controller 114 may implement instructions from the mobile device 162 (i.e., hub) to suspend functionality of one or more components of the radio 128 that render duplicative services during field operations. The instructions may be represented by control signals that can be received by the radio 128 from the mobile device 162. For example, based on the received instructions, the radio controller 114 may deactivate the microphone 104 and prevent the microphone 104 from detecting audio since the audio is also being captured by another device (body camera 132) or another microphone component (not shown) within the radio 128. In this example, the radio controller 114 may store status of the components of the radio 128 in the function status 120, which may be implemented in a storage device that is accessible by the radio controller 114.

Referencing the body camera 132, the body camera 132 may include a video sensor 170 and/or a microphone 172, and a communications interface 164. In one embodiment, the the communications interface 164 may use cellular communications, direct communications such as shared spectrum, and/or any other suitable wireless or wired communication techniques. In some cases, the communications interface 164 may be used to receive a software update notification for the body camera 132. The software update notification may be transmitted by a service provider that is registered in data of the body camera 132 as an authorized provider of the device driver update, for example. In other cases, the software update notification may be received from the hub-mobile device 162 that relays the notification from the authorized provider. In some implementations, the software update may be pushed to the body camera 132 or another hub-connected device without the software update notification either from the authorized provider of the device driver update and/or the hub-mobile device 162.

The body camera 132 may include body camera sensors 166 to detect characteristics of an environment at a geolocation of the body camera 132. For example, the body camera sensors 166 may include an accelerometer, a gyroscope, a GPS receiver, a barometer, an ambient light sensor, a compass, a gravity sensor, a proximity sensor, and/or any other similar sensors. As described herein, the detected characteristics of the environment may be used as a reference for installing of the software update. In this example, the body camera 132 also may include a battery 178 to provide power to the body camera sensors 166 and the other components of the body camera 132.

The body camera 132 may include a body camera controller 168 that is configured to manage some or all of the components of the body camera 132. The body camera controller 168 may be implemented by one or more processors executing software stored on a storage device accessible by the processors. The corresponding software for the components of the body camera 132 may be updated on the fly, at intervals, or upon receiving of an instruction from the hub-mobile device 162. In one embodiment, the body camera controller 168 may manage the processing of the audio data from the microphone 172 or process sensor data from the video sensor 170.

In one embodiment, the body camera controller 168 may implement instructions from the mobile device 162 (i.e., hub) to suspend functionality of one or more components of the body camera 132 that render duplicative services during field operations. The instructions may be represented by control signals that can be received by the body camera 132 from the mobile device 162. For example, based on the received instructions, the body camera controller 168 may deactivate the microphone 172 and prevent the microphone 172 from detecting audio since the audio is also being captured by another device (radio 128) or another microphone component (not shown) within the body camera 132. In this example, the body camera controller 168 may store status of the components of the body camera 132 in the function status 176, which may be implemented in a storage device that is accessible by the body camera controller 168.

Referencing the mobile device 162, which may be configured as the master device (i.e., hub) in the present implementation, the mobile device 162 may include a mobile device controller 138, communications interface 146, mobile device sensors 148, a function selector 150, and a context determiner 154. The mobile device controller 138 may be configured to manage some or all components of the mobile device 162 to facilitate the software updating in the radio 128 and/or the body camera 132. For example, the mobile device controller 138 may use the communications interface 146 to receive the software update notifications, transmit the notifications to the corresponding hub-connected devices, receive data for the software update to be installed in one or more hub-connected devices, or install the received data to the one or more hub-connected devices. In this example, the hub-connected devices may include the radio 128 and the body camera 132.

In one embodiment, the mobile device controller 138 may install the received data at a preconfigured time period or upon a detection of a triggering event. For example, the mobile device sensors 148 may detect overlapping services that are currently being rendered by the radio 128 and the body camera 132. The overlapping services, for example, may include capturing of audio during a field operation. In this example, the mobile device controller 138 may install the received data by suspending first the audio capturing functionality of the radio 128 or the body camera 132 and then push the received data for software updating. In another example, and during the rendition of the duplicative services, the mobile device sensors 148 may detect the battery charges of the radio 128 or the body camera 132 to be below threshold level. In this other example, the mobile device controller 138 may use this detected condition for the software updating.

The mobile device sensors 148 may identify nearby hub-connected devices, determine the devices that are capable and authorized to join the formed PAN, determine presence of duplicative services such as the capturing of the same audio by the activated radio 128 and body camera 132, and the like. The mobile device sensors 148 may include an accelerometer, a gyroscope, a GPS receiver, a barometer, an ambient light sensor, a compass, a gravity sensor, a proximity sensor, a magnetometer, image sensor, video sensor, microphone, hygrometer, water sensor, solar flux sensor, ultraviolet light detector, and/or any other similar sensors.

The context determiner 154 may determine the context of the mobile device 162 and/or the hub-connected devices. The context determiner 154 may analyze the mobile device sensor data, the radio sensor data, the body camera sensor data, and other data from the hub-connected devices. In one embodiment, the context determiner 154 may determine a likely context of the mobile device 162 and/or any of the hub-connected devices based on this analysis. The context may indicate the likely actions in which the user 130 may be participating, the activities that may likely be occurring around the user 130, the likely path of the user 130, the weather around the user 130, and/or any other similar context. In some embodiments, the timing for the software updating in the radio 128 and/or body camera 132 may use the context analysis from the context determiner 154 as a reference.

In some embodiments, the mobile device controller 138 may maintain a record or data of the hub-connected devices that the mobile device 162 manages. This record may include identifiers for each of the hub-connected devices, device characteristics, device functionalities, and the like. As shown, the mobile device 162 may include a connected devices storage 158 that is accessible by the mobile device controller 138. The connected devices storage 158 may include the device identifiers 152 that include that data for identifying each of the hub-connected devices, device driver software, or authorized provider for device driver update. The data may also include information about amount of data to be installed for the software update and amount of time to complete the software updating.

The connected devices storage 158 may also include the device characteristics 160 and the device functions 140 for the devices referenced in the device identifiers 152. The device functions 140 may include data related to the capabilities of the hub-connected devices, for example. The device functions 140 may be related to the tasks that the corresponding hub-connected device is configured to perform. In some implementations, the mobile device controller 138 may request the hub-connected devices to indicate their corresponding functions or capabilities. In some implementations, the hub-connected devices may provide an indication of their corresponding functions upon connecting to the hub-mobile device 162. In some implementations, the hub-connected devices may provide an indication of their corresponding functions upon an update to the functions of the device. For example, if a hub-connected device receives the software update that allows the device to perform a new function, then the device may provide an indication to the mobile device 162 indicating the new function. If a device loses a function, then the device may provide an indication to the mobile device 162 indicating the lost function.

The device characteristics 160 may store parameters such as hardware features of the devices in the formed PAN. For example, the device characteristics 160 may include type of batteries, configuration of the batteries, memory sizes, and other hardware features of the mobile device 162, radio 128, and body camera 132. In this example, the device characteristics 160 may be utilized by the mobile device controller 138 to determine the timing for the software updating. Example operations at different stages are further described below.

In stage A, the mobile device controller 138 may access the device identifiers 152 and determine that the radio 128 and the body camera 132 are communicating with the mobile device 162 as hub-connected devices. In some implementations, the mobile device controller 138 may initially determine or confirm the functionalities of the radio 128 and the body camera 132 as further described below. In case of overlapping functionalities, then the software updating may be implemented when the radio 128 and the body camera 132 are performing overlapping services.

In one instance, the mobile device controller 138 may send a function request 108 to the radio 128. The communications interface 116 of the radio 128 receives the function request 108 and provides the function request 108 to the radio controller 114. The radio controller 114 determines that the functions of the radio 128 may include the ability to capture audio, output audio, and communicate using cellular or direct wireless communications. The radio controller 114 may then transmit the function response 106 that indicates these functions. Upon receiving of the function response 106, the mobile device controller 138 stores the function response 106 in the device functions 140.

The mobile device controller 138 may also send a function request 188 to the body camera 132. The communications interface 146 of the body camera 132 receives the function request 188 and provides the function request 188 to the body camera controller 168. The body camera controller 168 determines that the functions of the body camera 132 include the ability to capture audio, capture video, communicate using Wi-Fi, or communicate using cellular or direct wireless communications, for example. The body camera controller 168 may then transmit the function response 186 that indicates these functions. Upon receiving of the function response 186, the mobile device controller 138 stores the function response 186 in the device functions 140.

In stage B, the mobile device controller 138 may determine device characteristics of the radio 128 and the body camera 132. The device characteristics may include hardware configuration, component identifications, or component status such battery power levels of the hub-connected device. In one embodiment, the mobile device controller 138 may send a characteristics request 110 to the radio 128. In turn, the radio controller 114 determines that the characteristics of the radio 128 include the battery 118 being at twenty percent capacity, current geolocation of the radio 128, and the like. The radio 128 may then send a characteristics response 124 that indicates these characteristics. Upon receiving of the characteristics response 124, the mobile device 162 may store the characteristics response 124 in the device characteristics 160.

The mobile device controller 138 may also send a characteristics request 182 to the body camera 132. In turn, the body camera 132 may determine that the device characteristics of the body camera 132 include the battery 178 being at ninety percent capacity, current geolocation of the body camera 132, and the like. The body camera controller 168 may then send the characteristics response 184 that can be stored by the mobile device 162 in the device characteristics 160.

In one embodiment, and at stage C, the mobile device controller 138 determines that the radio 128 and the body camera 132 may be currently performing duplicative services such as capturing of audio during field operations. In this embodiment, the mobile device controller 138 may leverage this condition when performing the software updating as described herein. For example, the mobile device controller 138 may use the function selector 150 to activate and/or deactivate one or more functionalities of the one or more hub-connected devices. In this example, the activation or deactivation may be implemented for purposes of the software updating. As further described elsewhere, the function selector 150 may also analyze the device functions 140 and the device characteristics 160 to determine whether to activate and/or deactivate one or more of functionalities of the hub-connected devices.

As illustrated in the example of FIG. 1, the function selector 150 may access the device functions 140 and determines similar functionalities between the hub-connected devices. For example, the function selector 150 may analyze the device functions 140 and determine that both the radio 128 and the body camera 132 are capable of capturing audio. In this example, the function selector 150 may further determine that it may be unnecessary for both the radio 128 and the body camera 132 to be capturing the same audio at the same time. This may occur when the user 130 is using both the body camera 132 and the radio 128 at the same time to capture audio and/or video data, for example.

In one implementation, and as shown in stage D, the mobile device 162 may send a control signal 126 that can represent an instruction for the radio 128 to deactivate the microphone 104 during the rendering of the overlapping services such as the concurrent capturing of the same audio by the radio 128 and the body camera 132. On the other hand, the mobile device 162 may send a control signal 180 that can represent an instruction for the body camera 132 to keep its microphone 172 active to capture the audio.

In some embodiments, the deactivation of the microphone of the radio 128 may facilitate the software updating of the one or more driver components in the radio 128. For example, the radio 128 may receive the data for the software updating directly from the authorized provider or the mobile device 162 may implement the installing of the data to the radio 128.

In one implementation, the instruction 180 may also include timing and/or set of conditions for the software updating of the body camera 132. The timing and/or set of conditions may be derived using models on the device functions 140, the device characteristics 160, context data from the context determiner 154, surrounding environmental conditions, and/or user-entered data.

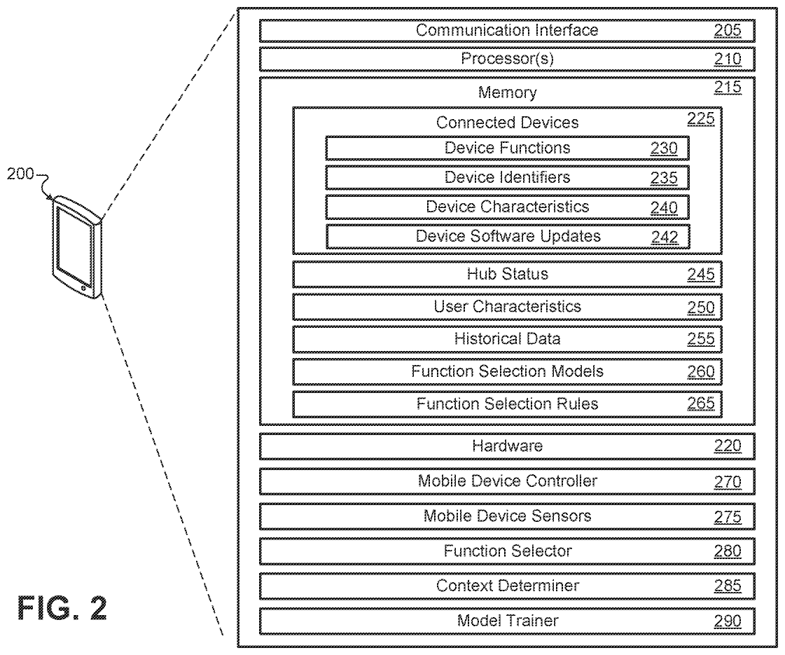

FIG. 2 illustrates an example device 200 that is configured as a hub to manage the functionality of the hub-connected devices. The device 200 may be similar to the mobile device 162 of FIG. 1. Some of the components of the device may be implemented in a single computing device or distributed over multiple computing devices.

The device 200 may include a communication interface 205, one or more processors 210, memory 215, and hardware 220. The communication interface 205 may include communication components that enable the device 200 to transmit data and receive data from other devices and networks. The hardware 220 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 215 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The one or more processors 210 may implement a mobile device controller 270, which can be similar to the mobile device controller 138 of FIG. 1. For example, the mobile device controller 270 may be configured to instruct the communications interface 205 to communicate with a first hub-connected device (e.g., radio 128) using short range radio and communicate with a second hub-connected device (e.g., body camera 132) using a cellular network. In this example, the mobile device controller 270 may implement the software updating of the radio 128, body camera 132, and/or other devices that are managed by the device 200. The tasks of the mobile device controller 270 may also include determining whether the device 200 should operate as the hub. The designation of the device 200 as the hub may be preconfigured among the formed PAN of devices or facilitated by a central management server such as the NOC server. The designation may be set for a particular time period, or triggered by a detection of a triggering event. For example, the vehicle laptop associated with the LEO is preconfigured to be the hub when the formed PAN of devices are connected with each other via a direct wireless communication interface. In another example, the LEO's mobile device such as the device 200 may be configured as the hub when a signal strength of the direct wireless communication interface between the LEO's mobile device and the vehicle laptop is below a threshold value. In these examples, each of the PAN devices may have a capability and authorization to form the PAN and/or manage some or all of the PAN devices when designated as the hub.

If the device 200 is operating as the hub, then the device 200 may operate as a gateway for communications between the hub-connected devices and/or another network. For example, the mobile device controller 270 may instruct a hub-connected device to cease communicating over the cellular network and communicate with the device 200 using short range radio or direct communications channel.

In some embodiments, the status of whether the device 200 is operating as the hub may be located in the mobile device status 245. The mobile device status 245 may be located in the memory 215 of the device 200. The mobile device status 245 may include data indicating whether the device 200 is operating as the hub. If the status data indicates that the device 200 is not operating as the hub, then the mobile device status 245 may include data identifying another PAN device that is currently operating as the hub.

The device 200 may include mobile device sensors 275. The mobile device sensors 275 may be similar to the mobile device sensors 148 of FIG. 1. In one embodiment, the mobile device sensors 275 may capture sensor data, and use the captured sensor data when implementing the software updating as described herein. For example, the mobile device sensors 275 may detect a direct communications signal strength between a hub-connected device and the device 200. In this example, the mobile device controller 270 may use the detected signal strength in addition to the detected overlapping functionality when performing the software updating for the corresponding hub-connected device. The detected overlapping functionality may include, for example, capturing of the same audio by different hub-connected devices.

The memory 215 may include the connected devices storage 225. The connected devices storage 225 may be similar to the connected devices storage 158 of FIG. 1 In one instance, the connected devices storage 225 may include the device functions 230, the device identifiers 235, device characteristics 240, and device software updates 242 that may be similar to the device functions 140, the device identifiers 152, device characteristics 160, and the device software updates 190 of FIG. 1, respectively.

The device characteristics 240 may store data of the hub-connected devices and the device 200. On the other hand, the device software updates 242 may store data related to historical data of the software updates that were installed in the hub-connected devices.

The device functions 230 may store data related to the hub-connected devices included in the device identifiers 235. The device functions 230 may be similar to the device functions 140 of FIG. 1. In one instance, the device functions 230 may include data that are related to the quality of the functions of each hub-connected device. For example, if the function is audio capture, then the quality may relate to the bitrate, sampling rate, and/or any other similar quality metric audio capture. If the function is video capture, then the quality may relate to resolution, framerate, and/or any other similar quality metric for video capture. If the function is to perform the software updating, then the quality may relate to speed of downloading speed data packets, speed of transmitting the downloaded data packets to the targeted hub member-device, or any other similar quality metric to perform the software updating.

The memory 215 may include user characteristics 250. The user characteristics 250 may include data that describe the type of user who is using the device 200 or other hub-connected devices. The type of user may include an occupation of the user, demographic information of the user, an employer of the user, and/or any other similar information.

The one or more processors 210 may implement a context determiner 285. The context determiner 285 may be similar to the context determiner 154 of FIG. 1. The context determiner 285 may be configured to determine a context of the device 200 and/or any of the hub-connected devices. The context determiner 285 may be configured to analyze the sensor data generated by the mobile device sensors 275 and/or sensor data generated by sensors of any of the hub-connected devices.

The context determiner 285 may also be configured to determine events that may be occurring near or around the device 200. The context determiner 285 may determine events by analyzing news sources, websites, internet locations with current event information, first responder dispatch feeds, and/or any other similar information source. In some implementations, the context determiner 285 may access communications between the device 200 and other hub-connected devices.

The one or more processors 210 may implement a function selector 280. The function selector 280 may be similar to the function selector 150 of FIG. 1. The function selector 280 may be configured to analyze the device functions 230, the device characteristics 240, the sensor data from the mobile device sensors 275, the sensor data from the connected devices, the context, the user characteristics 250, and/or any other similar data to determine whether any function of the hub-connected devices can operate differently than how that function typically operates. The function selector 280 may use the function selection models 260 and/or the function selection rules 265 to analyze these data sources. The function selection models 260 and/or the function selection rules 265 may output data identifying one or more functions of the hub-connected devices and data indicating how those functions should operate. The function selector 280 may output those instructions to the corresponding hub-connected device.

The function selection rules 265 may include various thresholds, ranges, hierarchies, and/or any other similar comparison tools to determine how the functions of the hub-connected devices should operate. An example rule may indicate to identify the hub-connected devices that are capable of performing the same function. The rule may indicate for the device with the higher battery capacity to perform the function if both devices would otherwise be performing that function. For example, a body camera and a radio may both have a microphone. The radio may have more battery capacity. If the body camera receives a request to begin capturing audio and the radio has not received a request to begin capturing audio, then the body camera may continue to capture the audio. If the body camera receives a request to begin capturing audio and the radio has received a request to begin capturing audio or is capturing audio, then the body camera may bypass capturing the audio. The mobile device controller 270 may coordinate the operation of these functions by requesting that the hub-connected devices notify the mobile device controller 270 when the connected device receives a request to start or stop using one of these functions.

A similar rule may indicate for the hub-connected device with the higher battery capacity to perform the function even if both hub-connected devices would not be performing the function. Following the body camera and radio example, the radio may have more battery capacity. If the body camera receives a request to begin capturing audio and the radio has not received a request to begin capturing audio, then the body camera may bypass capturing audio and the radio may begin capturing audio on behalf of the body camera. In this case, the radio may provide the captured audio to the mobile device controller 270 and the mobile device controller 270 may output the audio captured by the radio and provide the captured audio to the location or device where the body camera would provide the audio if the body camera captured the audio. If the body camera receives a request to begin capturing audio and the radio has received a request to begin capturing audio or is capturing audio, then the body camera may bypass capturing the audio. The radio may begin capturing audio for both the body camera and the radio. The radio may transmit the audio to the device that the radio would typically send the audio and to the mobile device controller 270. The mobile device controller 270 may provide the audio to the location or device where the body camera would provide the audio if the body camera captured the audio.

Another example rule may be related to ensuring that the highest quality audio, video, image, or other data is collected. The rule may specify for the image sensor with the highest resolution to capture the video and/or images. In this case, the communication between the devices may be similar to that described above with respect to the audio capturing.

Another example rule may be related to device 200 acting as the hub for the connected devices. The rule may state that the hub-connected devices may communicate with the device 200 using short range radio and the device 200 may transmit communications from the connected devices and receive communications for the connected devices. The device 200 may use higher power communications such as cellular communications. In other words, the device 200 acts as a communication point for the connected devices because the device 200 communicates on behalf of the connected devices.

In some implementations, this rule may also include references to the battery power of the connected devices and/or the device 200. For example, the rule may not apply if the battery capacity of the connected device is above sixty percent. As another example, the rule may not apply if the battery capacity of the device 200 is below forty percent. As another example, the rule may apply if the device 200 has a hardwired power supply. As another example, the rule may not apply if the signal strength of the device is below a threshold signal strength. As another example, the rule may indicate that one of the connected devices or the device 200 should operate as the communication hub if one of the connected devices or the device 200 has a signal strength that is above a threshold and the other devices have a signal strength that is below a threshold. This rule may be valid for devices that are capable of communicating with additional devices that the ones that the devices are intended to communicate with.

In one implementation, an example rule may be related to ensuring that the software updating may be implemented during a downtime period of the associated police officer where functionalities of the connected devices are not affected. Here, the software updating may be implemented when the corresponding device is in a location where it is not likely to be actively used for field or office operations. The rule may specify the timing, set of conditions, or the event that can trigger the software updating.

The function selection models 260 may be configured to receive the device functions 230, the device characteristics 240, the sensor data from the mobile device sensors 275, the sensor data from the connected devices, the context, the user characteristics 250, and/or any other similar data. The function selection models 260 may output data indicating a function of a hub-connected device to adjust and how to adjust that function. The function selection models 260 may be trained using machine learning and the historical data 255. The historical data 255 may include previous sensor data collected from the device mobile device sensors 275, previous sensor data collected from the sensors of the hub-connected devices, previous contexts, previous user characteristics, previous successful software updates, previous timing and set of conditions for the software updating, and/or any other similar data. The historical data 255 may also include data related to instances when the device 200 may have been managing the functions of the hub-connected devices.

The one or more processors 210 may implement the model trainer 290. The model trainer 290 may be configured to analyze the historical data 255. The model trainer 290 may train the function selection models 260 using the historical data 255 and machine learning. The model trainer 290 may generate various data samples based on the historical data 255. Each data sample may indicate the state of the previous sensor data collected from the mobile device sensors, previous sensor data collected from the sensors of the connected devices, previous contexts, previous user characteristics, previous software updating, and/or any other similar data at a point in time. Each data sample may also include a label that indicates the state of the various functions of the connected devices and how the devices were communicating with each other and/or with other devices and networks. The resulting models may be able to receive device functions 230, the device characteristics 240, the sensor data from the mobile device sensors 275, the sensor data from the connected devices, the context, the user characteristics 250, and/or any other similar data and output data indicating which functions should be active or inactive, how the hub-connected devices may communicate with the device 200, timing of the software updating, and/or any other similar recommendation.

In some implementations, the function selector 280 may implement the recommendation and particularly, the timing of the software updating. The model trainer 290 may continue to collect the historical data 255 as the device 200 operates. In this case, the model trainer 290 may update the historical data 255 and retrain the function selection models 260 using the updated historical data 255 and machine learning. The function selector 280 may utilize the updated function selection models 260 to analyze the device functions 230, the device characteristics 240, the sensor data from the mobile device sensors 275, the sensor data from the connected devices, the context, the user characteristics 250, and/or any other similar data that may have updated since the last analysis.

The model trainer 290 may also be configured to analyze the historical data 255 and generate the function selection rules 265. The model trainer 290 may analyze the historical data 255 for patterns to identify the timing of the software updating and other similar comparison techniques to use to analyze the device functions 230, the device characteristics 240, the sensor data from the mobile device sensors 275, the sensor data from the connected devices, the context, the user characteristics 250, and/or any other similar data. In some implementations, the model trainer 290 may receive goals from a user that the model trainer 290 should try to achieve when generating the function selection rules 265. For example, the goals may include preserving battery life, ensuring completion of the software updating without unnecessary use of memory spaces and battery power, ensuring image resolution is above a threshold a certain percentage of the time, ensuring the framerate is above a threshold a certain percentage of the time, and/or any other similar goal.

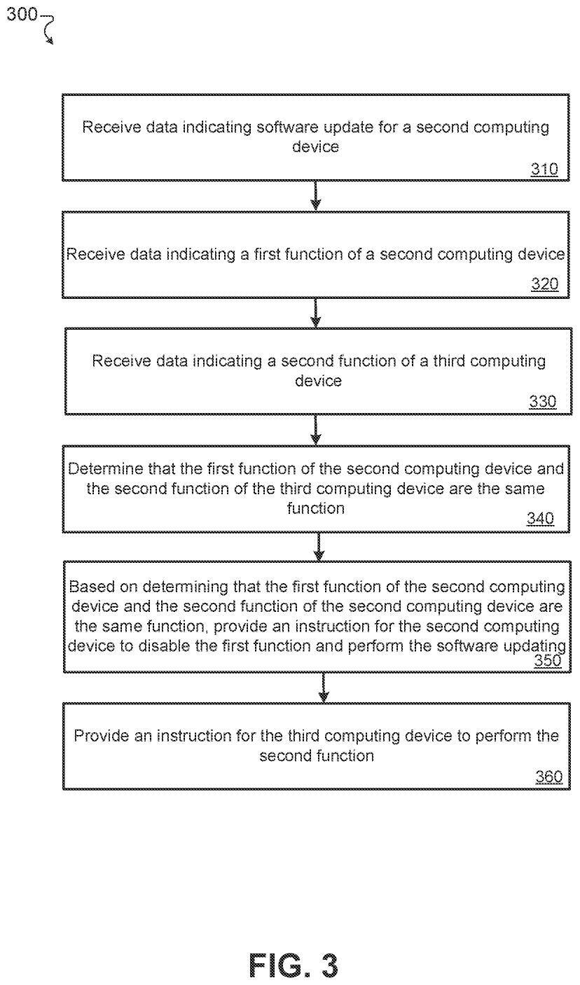

FIG. 3 is a flowchart of an example process 300 for managing the functionality of various devices. In general, the process 300 determines the functions that various devices are capable of performing. The process 300 determines that some of those functions are the same function. Based on that determination, the process 300 may instruct one of the devices to cease performing that function in order to prevent that device from performing redundant functions and thus capable of performing another function such as the software updating as described herein. The process 300 may be described as being performed by the mobile device 162 of FIG. 1 and will include references to other components in FIG. 1. The process 300 may also be performed by the device 200 of FIG. 2.

The mobile device 162 may receive data indicating a software update for a second computing device (310). In some implementations, the mobile device 162 (hub) is connected to a second computing device (hub-connected device) and receives a notification for the software update of one or more components of the hub-connected device. For example, the software updates may relate to the software of device functionalities of capturing audio and/or video, software for sensors to gather sensor data, software for the mobile device controller to perform its functions, software for the context determiner, and the like. In this example, the mobile device 162 may perform the software updating when the second computing device is detected to include an overlapping functionality with another hub-connected device or the hub-mobile device 162. As described above, the mobile device 162 may use the model device controller to determine the timing for the software updating. For example, the software updating may be performed when there is a detected overlapping of services performed by two or more devices in the formed PAN. In another example, the timing for the software updating may be determined using the function selection models 260 and function selection rules 265 of the hub-mobile device.

In some embodiments, the mobile device 162 may initially download the data packets for the software update. The mobile device 162 may then identify the timing for the software updating by detecting status of the hub-connected device, presence of overlapping services, location of the hub-connected device, environmental conditions that allows short range radio communications for transmission of the downloaded data packets, and the like. In this example, and using the detected overlapping services, status, environmental conditions, and other data, the mobile device 162 may perform the software updating of the second computing device.

The mobile device 162 may receive data indicating a first function of the second computing device (320). In some implementations, the first function may be related to actions that the hardware and/or software of the second computing device can perform. For example, the first function may be capturing audio, capturing images, capturing video, communicating using RF communications, communicating using short-range radio, communicating using infrared, communicating using Wi-Fi, communicating using a cellular network, detecting temperature, detecting acceleration, detecting motion, detecting location, detecting pressure, detecting ambient light, detecting cardinal direction, detecting gravity, detecting the proximity of objects, detecting magnetic fields, detecting water, detecting solar flux, detecting ultraviolet light, and/or performing any other similar function. In some implementations, the second computing device may be any type of device that is capable of communicating with the mobile device 162 and/or other devices.

The mobile device 162 may receive data indicating a second function of a third computing device (330). The second function of the third computing device may be similar to, and thus overlapping with, the first function of the second computing device. In some implementations, the overlapping functions or services may be leveraged for the software updating of the second computing device or the third computing device. The third computing device may be any type of device that is capable of communicating with the mobile device 162 and/or other devices.

The mobile device 162 may determine that the first function of the second computing device and the second function of the third computing device are the same function (340). The mobile device 162 may make this determination by comparing the input and/or output of the functions, the initialization process for the function, the termination process for the function, and/or any other similar aspect of the functions. For example, the mobile device 162 may determine that the second and third computing devices both perform audio capture. In this example, the mobile device 162 may determine that the second and third computing devices both perform overlapping functionalities or services.

Based on determining that the first function of the second computing device and the second function of the second computing device are the same function, the mobile device 162 provides an instruction for the second computing device to disable the first function and perform the software updating (350). The instruction may include the timing of the software updating to avoid disruption of field operation tasks such as, for example, capturing audio using the first function. The mobile device 162 may then provide, for output to the third computing device, the instruction for the third computing device to perform the second function (360). In some implementations, the instruction to perform the second function may indicate for the second function to remain active until the mobile device 162 provides an instruction to the third computing device to return the second function to inactive operation.

In some implementations, the instruction to disable the first function may not be an instruction to prevent activation of the function. Instead, the instruction may be for the second computing device to request permission from the mobile device 162 to disable. In this case, the goal may be to prevent multiple devices from performing the same function at the same time. If neither is performing the function, then one of them can activate the function. If both are performing the function, then the mobile device 162 specifies in the instructions whether the device should defer to the other device and deactivate the function. For example, the third computing device may indicate to the mobile device 162 when the third computing device would activate the microphone. The mobile device 162 may determine whether the second computing device has an active microphone. If so, then the mobile device 162 may instruct the third computing device to not activate the microphone. If not, then the mobile device 162 may permit the third computing device to proceed with activating the microphone. The mobile device 162 may also instruct the second computing device to notify the mobile device 162 regarding the status of the microphone of the second computing device and provide the audio data of the microphone to the mobile device 162, if instructed.

In some implementations, the mobile device 162 may receive the characteristics of the second and third computing devices. In some implementations, the characteristics may be related to the aspects of the devices that are not related to the devices performing an action. In some implementations, the device functions may be related to the functions of the devices that may change with changes in hardware and/or software, and the device characteristics may be other aspects of the devices that may change without changes in hardware and/or software. In some implementations, the characteristics may be related to the functions. For example, the characteristics may relate to the resolution of a camera, a framerate of a video sensor, a sampling rate of a microphone, a resolution of the microphone, a bandwidth of a communication channel, the signal strength of a communication signal, and/or any other similar aspect of a function. In some implementations, the function characteristics may change over time. For example, the signal strength may increase and decrease as the environment of the devices changes and/or the devices move.

In some implementations, the mobile device 162 may use both the characteristics and the functions to determine whether to deactivate, perform the software updating, or modify the performance of the second function of the third computing device. For example, the mobile device 162 may select the device to perform the function based on which device has the most battery capacity remaining. In some implementations, the characteristics of the devices may change over time. This may cause the mobile device to change which device is performing the function. For example, the mobile device 162 may determine that the battery capacity of the second computing device has dropped below the battery capacity of the third computing device. In this case, the mobile device 162 may switch the device performing the function so that the third computing device is performing the function and the second computing device is requesting permission and/or not performing the function.

In some implementations, the mobile device 162 may determine the context of the mobile device 162, the second computing device, and/or the third computing device. The mobile device 162 may analyze sensor data collected from the mobile device 162, the second computing device, and/or the third computing device, weather information, news information, traffic information, event information, and/or any other similar data source. Based on this analysis, the mobile device 162 may determine the context. The mobile device 162 may utilize the context to assist in selecting which device should perform the function.

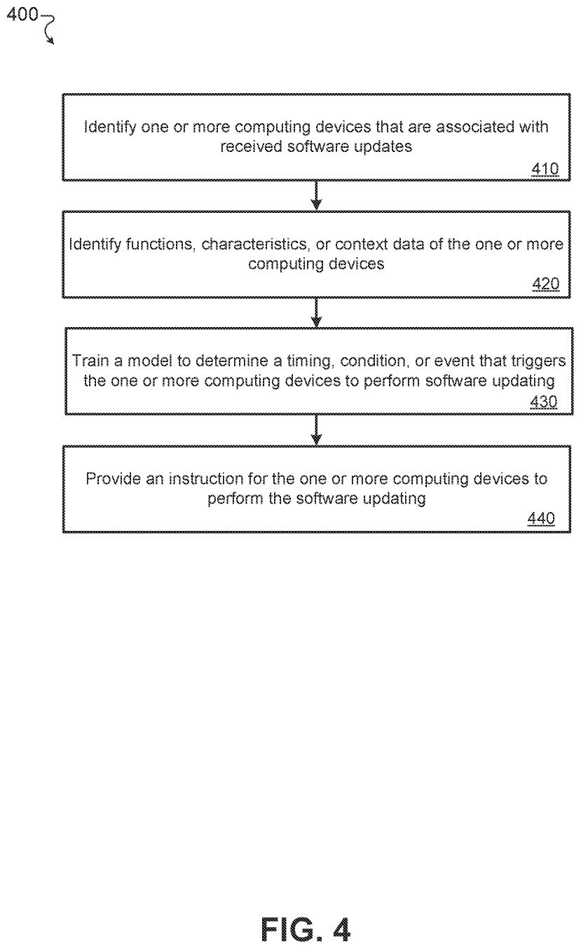

FIG. 4 is a flowchart of an example process 400 for managing the functionality of various devices. In general, the process 400 determines the timing, set of conditions, and/or events that trigger the software updating by the connected devices. Based on that determination, the process 400 may instruct the connected devices to perform the software updating without disrupting services of capturing audio, video, etc. during field operations by the associated police officer. The process 400 will be described as being performed by the mobile device 162 of FIG. 1 and will include references to other components in FIG. 1. The process 400 may also be performed by the device 200 of FIG. 2.

At block 410, the mobile device 162 may identify one or more computing devices that are associated with received software updates as described herein. In one example, the mobile device 162 as the configured hub may subscribe to receive notifications of software updates for the hub-connected devices. In some cases, the mobile device 162 may download the data packets for the software updates. In this example, the mobile device 162 may facilitate the software updating via short range radio or in some cases, the connected computing device may directly perform the software updating upon instruction of the mobile device 162.

At block 420, the mobile device 162 identifies functions, characteristics, or context data of the one or more computing devices as described herein. By training the models described herein to the identified functions, characteristics, or context data, the mobile device 162 may determine a timing, condition, or event that triggers the one or more computing devices to perform the software updating (block 430) as described herein.

At block 440, the mobile device 162 may provide an instruction for the one or more computing devices to perform the software updating based on the output of the trained model as described herein.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed:

1. A computer-implemented method, comprising:
receiving, by a first computing device, data indicating a software update for a second computing device;
receiving, by the first computing device, data indicating a first function of the second computing device;
receiving, by the first computing device, data indicating a second function of a third computing device;
determining, by the first computing device, that the first function of the second computing device and the second function of the third computing device are the same function;
based on determining that the first function of the second computing device and the second function of the second computing device are the same function, providing, by the first computing device, an instruction for the second computing device to disable the first function and perform software updating; and
providing, by the first computing device, an instruction to the third computing device to perform the second function.

2. The computer-implemented method of claim 1 further comprising:
downloading data packets of the software update;
determining, by the first computing device, a timing for software updating; and
based on the determined timing, sending the data packets to the second computing device via a short range radio.

3. The computer-implemented method of claim 1 further comprising:
downloading data packets of the software update;
determining, by the first computing device, a condition for sending of the data packets to the second computing device; and
in accordance with an occurrence of the determined condition, sending the data packets to the second computing device via a short range radio.

4. The computer-implemented method of claim 3, wherein the condition includes a detection the second computing device capturing an audio that is also being captured by the third computing device.

5. The computer-implemented method of claim 1 further comprising:
determining a characteristic of the second computing device; and
providing the instruction to the second computing device to perform the software updating based on a determined characteristic of the second computing device.

6. The computer-implemented method of claim 1 further comprising:
determining amount of battery charge of the second computing device to be below threshold level; and
providing the instruction to the second computing device to perform battery charging before performing the software updating based on a determined amount of battery charge to be below the threshold level.

7. The computer-implemented method of claim 1, wherein the software update includes over the air software or firmware update.

8. The computer-implemented method of claim 1, wherein the first computing device is configured as a hub in a personal area network that includes the second computing device and the third computing device.

9. The computer-implemented method of claim 1 further comprising:
determining, by the first computing device, an event that triggers the software updating of the second computing device; and
based on a determined event, providing, by the first computing device, the instruction to the second computing device to perform the software updating upon a detection of the event.

10. One or more non-transitory computer-readable media of a computing device storing computer-executable instructions that upon execution cause one or more computers to perform acts comprising:
receiving, by a first computing device, data indicating a software update for a second computing device;
receiving, by the first computing device, data indicating a first function of the second computing device;
receiving, by the first computing device, data indicating a second function of a third computing device;
determining, by the first computing device, that the first function of the second computing device and the second function of the third computing device are the same function;
based on determining that the first function of the second computing device and the second function of the second computing device are the same function, providing, by the first computing device, an instruction for the second computing device to disable the first function and perform software updating; and
providing, by the first computing device, an instruction to the third computing device to perform the second function.

11. The one or more non-transitory computer-readable storage media of claim 10, wherein the acts further comprise:
downloading data packets of the software update;
determining, by the first computing device, a timing for software updating; and
based on the determined timing, sending the data packets to the second computing device via a short range radio.

12. The one or more non-transitory computer-readable storage media of claim 10, wherein the acts further comprise:
downloading data packets of the software update;
determining, by the first computing device, a condition for sending of the data packets to the second computing device; and
in accordance with an occurrence of the determined condition, sending the data packets to the second computing device via a short range radio.

13. The one or more non-transitory computer-readable storage media of claim 12, wherein the condition includes a detection the second computing device capturing an audio that is also being captured by the third computing device.

14. The one or more non-transitory computer-readable storage media of claim 10, wherein the acts further comprise:
determining a characteristic of the second computing device; and
providing the instruction to the second computing device to perform the software updating based on a determined characteristic of the second computing device.

15. The one or more non-transitory computer-readable storage media of claim 10, wherein the acts further comprise:
determining amount of battery charges of the second computing device to be below threshold level; and
providing the instruction to the second computing device to perform battery charging before performing the software updating based on a determined amount of battery charges to be below the threshold level.

16. The one or more non-transitory computer-readable storage media of claim 10, wherein the software update includes over the air software or firmware update.

17. The one or more non-transitory computer-readable storage media of claim 10, wherein the first computing device is configured as a hub.

18. A server-implemented system, comprising:
one or more processors;
computer-executable instructions stored in a memory that, if executed by the one or more processors, cause the one or more processors to perform operations comprising:
receiving, by a first computing device, data packets for an over the air software update for a second computing device;
receiving, by the first computing device, data indicating a first function of the second computing device;
receiving, by the first computing device, data indicating a second function of a third computing device;
determining, by the first computing device, that the first function of the second computing device and the second function of the third computing device are the same function;
based on determining that the first function of the second computing device and the second function of the second computing device are the same function, providing, by the first computing device, an instruction for the second computing device to disable the first function and perform software updating; and
providing, by the first computing device, an instruction to the third computing device to perform the second function.

19. The server-implemented system of claim 18, wherein the operations further comprise:
downloading data packets of the software update;
determining, by the first computing device, a timing for software updating; and
in accordance with an occurrence of the determined timing, sending the data packets to the second computing device via a short range radio.

20. The server-implemented system of claim 18, wherein the operations further comprise:
downloading data packets of the software update;
determining, by the first computing device, a condition for sending of the data packets to the second computing device; and
in accordance with an occurrence of the determined condition, sending the data packets to the second computing device via a short range radio.
